(19) United States
(12) Patent Application Publication
(10) Pub. No.: US 2006/0080971 A1
(43) Pub. Date: Apr. 20, 2006

(54) Power trailer structural elements for air flow, sound attenuation and fire suppression

(75) Inventors: Scott W. Smith, Palm Beach Gardens, FL (US); William J. Hartig, (US); Brian D. Hulse, Harrells, NC (US)

Correspondence Address: MORRISON & FOERSTER LLP, 1650 TYSONS BOULEVARD, SUITE 300, MCLEAN, VA, 22102, US

(73) Assignee: Vulcan Capital Management

(21) Appl. No.: 11/074,944

(22) Filed: Mar. 9, 2005

Related U.S. Application Data
(60) Provisional application No. 60/551,019, filed on Mar. 9, 2004.
(60) Provisional application No. 60/551,020, filed on Mar. 9, 2004.
(60) Provisional application No. 60/551,024, filed on Mar. 9, 2004.
(60) Provisional application No. 60/551,026, filed on Mar. 9, 2004.
(60) Provisional application No. 60/551,027, filed on Mar. 9, 2004.
(60) Provisional application No. 60/551,028, filed on Mar. 9, 2004.
(60) Provisional application No. 60/551,029, filed on Mar. 9, 2004.
(60) Provisional application No. 60/551,034, filed on Mar. 9, 2004.

(51) Int. Cl. F02C 7/20

(52) U.S. Cl. 60/797

(57) ABSTRACT

An enclosure comprising elements for air management, sound attenuation and fire suppression in a trailer-mounted mobile electrical power generation system. Air management is provided by ducts, fans, seals and a barrier wall. In addition, by establishing airflow away from spark-producing equipment, any fuel that might leak will not accumulate near the spark-producing equipment, and thus fire and explosion risks are reduced. Targeted sound suppression in the ducts, walls, floor and ceiling of the enclosure provides acceptable noise levels. Fire detectors, a fire suppression system and dampers allow for quickly controlling fires inside the enclosure. A roof panel sealing system provides access into the enclosure during assembly and maintenance while providing a watertight and noise tight seal during transit and operations.

### CROSS-REFERENCE TO RELATED APPLICATIONS

This application claims the benefit of U.S. Provisional Application Nos. 60/551,019, 60/551,020, 60/551,024, 60/551,026, 60/551,027, 60/551,028, 60/551,029 and 60/551,034 filed Mar. 9, 2004, which are hereby incorporated by reference in their entirety.

### FIELD OF THE INVENTION

The invention relates to an air management system for a structure, and more particularly, to an enclosure comprising components for air management, sound attenuation and fire suppression in a trailer-mounted mobile electrical power generation system.

### BACKGROUND OF THE INVENTION

Mobile power generation systems capable of delivering several or more megawatts of power have been known to offer certain advantages compared to power delivered from the electrical power or utility distribution grid. The mobile power generation systems can provide power as needed at times of peak demand or of brownout in the distribution grid, or in cases of need because of some emergency or other problem in the distribution grid as a result of a power grid failure or some other type of disaster. The mobile power generation systems also can be located at places distant from the distribution network where there is a need for power. There is then no need for the delay or expense of arranging for or construction of power lines to the distant or remote places. Some years ago, there were attempts made to provide electric power in trailer-mounted generator systems. An example of such a trailer mounted generator system is described in a magazine article entitled “Megawatts on Wheels” written by C. F. Thompson, C. R. Boland and E. Bernstein in the March 1971 issue of Combustion, pages 24-30. For various reasons, these types of generator systems did not, so far as is known, achieve any extended use and were not widely adopted.

As noted above, mobile power generation systems have certain desirable features and advantages. They have again recently become the subject of interest. However, there are a number of factors that give rise to problems with these earlier types of trailer mounted generator systems.

For optimum use, such a system needs to comply with weight and height restrictions from relevant highway regulatory and governmental agencies. Also, there are environmental limitations on the type and acceptable concentration levels of combustion waste products produced by this equipment. In addition, noise from the various components of the generator systems must be kept within presently established regulatory limits.

There were competing considerations regarding mobile power generation systems of this type. On the one hand, limits on weight and size of the systems had to be observed if the systems were to be highway transportable and thus available for widespread use. In conflict with this were the environmental and noise abatement considerations. Further, mobile power generation systems should be self-supporting in that they could bring to the site all equipment necessary to assemble the system in a relatively few days without the need for other equipment such as cranes, hoists and the like. It was felt by at least some that achieving suitable limits on combustion gas product emissions and noise levels could not be achieved while complying with height and weight limits for highway travel.

An example of a system that provides an improved mobile trailer-mounted power generation system is described in U.S. Pat. No. 6,786,051 to Kristich and Hulse, which is hereby incorporated by reference in its entirety. The mobile power system described there includes a gas generator burning a hydrocarbon fuel for creation of combustion gases that is operably interconnected with a free turbine that receives combustion gases and rotates a turbine shaft in response thereto. An electrical generator is mounted in communication with the free turbine for the generation of electricity upon rotation of the turbine shaft. A trailer body that is towable by a conventional tractor or truck is provided having a floor on which the gas generator, free turbine and electrical generator are mounted. The trailer body has end and side walls and a roof enclosing the gas generator, free turbine and electrical generator.

The trailer body is provided with an air inlet near one end for passage of air to the gas generator, and the free turbine has an exhaust for exit of the combustion gases. The trailer body has a combustion gas outlet formed in a side wall thereof for exit of the combustion gases from the free turbine. The gas generator, free turbine and electrical generator each have a longitudinal axis about which certain of their power generating components rotate during their operation. The longitudinal axes of the gas generator, free turbine and electrical generator are longitudinally aligned along a common axis along the longitudinal extent of the floor of the trailer body. This mobile trailer-mounted power generation system is easily connectable to other road-transportable units that provide for removal of undesirable components of the combustion gases without increasing the height or width of the trailer body of the power generation system. The mobile, trailer-mounted power generation system permits modularization of components to achieve generation of electrical power from a road-transportable unit while complying with height and weight limits for highway travel and also meeting both noise and environmental requirements.

However, even with the advances noted above, there are still a number of areas requiring improvement. The first issue is air management. Air management is important on the trailer because the various machines require cooling air around them. The machines give off heat while running and that heat has to be dissipated or it could build up to a point where a fire could develop. Also, a need exists to reliably transport and monitor a sufficient quantity of-air through the system to provide the amount of cooling required by the machinery located inside the enclosure.

Also, moving air into and out of a confined area, such as a trailer, and circulating it can create large amounts of noise because the air may be transported through a somewhat torturous path and then expelled. In addition, the equipment associated with the airflow, such as fans and electric motors, produces noise. If a mobile power generation system is too noisy, it may be limited in terms of places at which the unit can be operated. For example, too much noise from the system could create a problem in siting the unit in an area with a heavy population density. This may be the case in a power generating station that is using a gas turbine or a jet engine as its prime mover. As is well known, a jet engine is an extremely loud device. It is not uncommon for sound pressure levels close to a jet engine to reach anywhere from 120-140 dba. Additionally, any place where air leaks or can be transmitted from the mobile power system also creates sound leaks. This results in a need to seal the enclosures to minimize the amount of air leaking through undesired paths. Thus, the attenuation of noise associated with air management would be a great improvement.

Another important issue concerns the ventilation around an alternating current (AC) generator. This has been a challenge when the prime mover is, for example, a gas turbine, which can be fueled by either liquid fuel or gaseous fuels. The AC generator is a machine that has a potential to make sparks. Having fuels around such a spark-producing device creates a challenge to keeping the system safe.

Similarly, should a fire develop, there is a need to quickly detect the fire and extinguish it. This can be extremely challenging in the setting of a mobile, modular, power generation system.

Accordingly, a need exists for air management, sound attenuation and fire suppression in a trailer-mounted mobile electrical power generation system.

### SUMMARY OF THE INVENTION

The present invention is directed to new and improved structural elements for air management, sound attenuation and fire suppression in a trailer-mounted mobile electrical power generation system.

One embodiment of the present invention may include an enclosure comprising a floor, end and side walls and a roof. There may also be a plurality of ducts connected to the enclosure. The enclosure may also include a combustion gas exhaust opening. One embodiment may include a plurality of devices to circulate air through the enclosure. In one embodiment, there may be at least one interior wall separating the enclosure into at least two compartments.

In one embodiment, the ducts may be removable. The ducts may also include screens, filters, devices to attenuate sound, devices to direct airflow and devices to stop airflow.

Another embodiment can include fire and explosive gas detection systems and a fire suppression system.

Another embodiment can include removable and sealable covers for openings in the enclosure.

In another embodiment, an interior wall may include an opening to allow a rotatable shaft or coupling to pass through. This opening may be sized to allow a pressure differential to exist across the two sides of the wall.

In one embodiment, the floors, walls, roof and ducts may include elements to suppress sound.

Another embodiment may include expansion joints on the inside and outside of the combustion gas exhaust opening.

### BRIEF DESCRIPTION OF THE DRAWINGS

These and other features, aspects and advantages of the present invention will become better understood with regard to the following description, appended claims and accompanying drawings where:

FIG. 1 shows an example of an isometric view of an enclosure comprising structural elements for air management, sound attenuation and fire suppression in a trailer-mounted mobile electrical power generation system.

FIG. 2 shows an example of a side elevation view of an enclosure comprising structural elements for air management, sound attenuation and fire suppression in a trailer-mounted mobile electrical power generation system.

FIG. 3 shows an example of a top plan view of an enclosure comprising structural elements for air management, sound attenuation and fire suppression in a trailer-mounted mobile electrical power generation system.

### DETAILED DESCRIPTION OF THE INVENTION

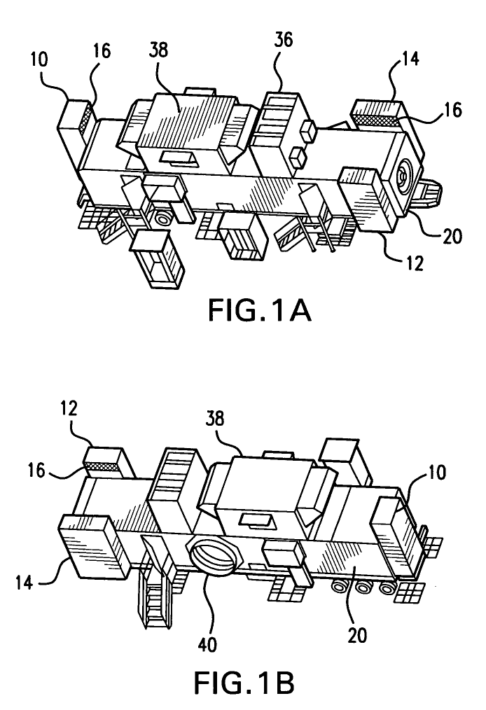

FIG. 1 shows an example of one embodiment of an enclosure comprising structural elements for air management, sound attenuation and fire suppression in a trailer-mounted mobile electrical power generation system. In FIG. 1, an enclosure comprising structural elements for air management, sound attenuation and fire suppression in a trailer-mounted mobile electrical power generation can include one or more air inlets. In one embodiment, one inlet 10 can be for an electrical generator. Another inlet 12 can be for a free turbine. Another inlet 14 can be for a gas generator. These inlet structures may have screens 16 provided to keep foreign objects such as debris, birds and small animals from getting into an air inlet.

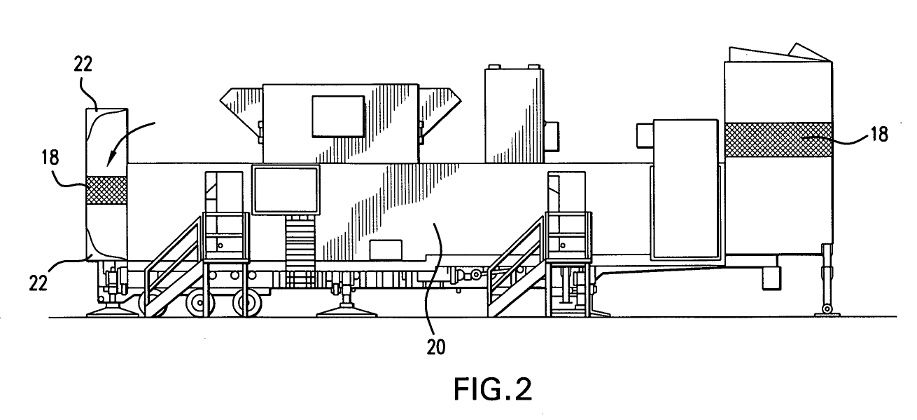

Referring to FIG. 2, downstream of the screens 16, air may pass through a set of silencers 18 in each of a series of ducts and these silencers 18 may attenuate sound from air moving into a trailer 20 and also from any leakage from the machines inside the trailer 20 that might be otherwise communicated back out thought the ducts. Each of the intake ducts may have airflow directional devices 22 at the top and at the bottom to help smooth the airflow and direct it down through the silencers 18. Once the air passes in through the silencers 18, it may then be directed by an airflow directional device 22 into the trailer 20.

Each of the intake ducts may have lifting lugs at the top and may also have slots of the bottom for positioning on the trailer 20. The ducts may be installed at the site and may be transported separately. The ducts may be positioned with pins that are at the top of the trailer. Once a duct is positioned, it may be fastened to the trailer 20. Suitable fasteners include bolts. In one embodiment, a suitable seal may be achieved by placing a gasket-type device between a flange on the duct and the trailer 20. During transportation, there may be a cover panel that covers the opening in the trailer 20 to which a duct is fastened. In one embodiment, the cover panel may be removed and stored once on site. The same bolts used to fasten the cover panel may be used to fasten the duct. One reason that these ducts may be removable is to allow the trailer 20 to be transportable over most roads in North America, specifically the federal highway system, without permits that may otherwise be required by regulatory agencies. In one embodiment, the ducts may be removable and may be transported via separate trailer.

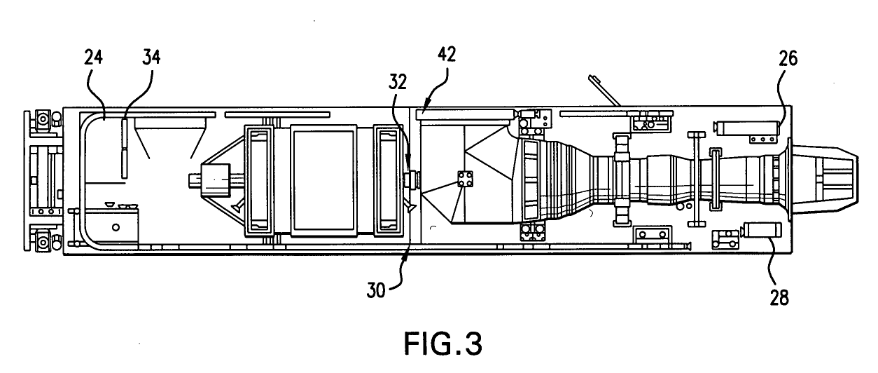

Turning to FIG. 3, once air passes into trailer 20 thought the ducts, there may be heat exchangers. For example, in one embodiment, there may be a heat exchanger 24 for the electrical generator lubricating oil. There may also be a heat exchanger 26 for a gas generator lubricating oil system and another heat exchanger 28 for a free turbine lube oil system. These heat exchangers may sit directly in front of the entrance point inside trailer 20 of the air ducts so that as air enters trailer 20, one of the first things this air does may do is cool the lubricating oil for the various machines. Although most of the air may go through the heat exchangers, in one embodiment there may be some air that may bypass the heat exchangers in the section containing the gas turbine and go directly into the part of trailer 20 containing the gas turbine.

In one embodiment, a barrier wall 30 may be erected between the section containing the gas generator and free turbine and the section containing the electrical generator. In one embodiment, the barrier wall 30 may be formed in two sections. One section may be fixed to the floor and side walls of the trailer 20. The other section may be movably mounted in a fixed position. The movable section may provide access to the coupling 32 and generator shaft between the free turbine and the electrical generator. In one embodiment, the wall 32 may be liftable and insertable through the roof of the trailer 20. The barrier wall 30 may serve to limit the amount of air communicated between the two compartments. Air may still flow through an opening that may be provided in a lower portion of the movable wall for the coupling shaft 32 that drives the electrical generator from the free turbine. The size of the opening for that shaft 32 may be calculated so that a differential pressure between the two compartments may be established. In one embodiment, the air pressure around the electrical generator may be higher than the air pressure around the gas turbine so air may flow from the electrical generator compartment to the gas turbine compartment and not vice versa. Preferably, by causing air to flow from the electrical generator compartment to the gas turbine compartment, fuel that might leak near the gas turbine does not accumulate in the compartment with the electrical generator where there might be sparks. This situation could result in a fire or explosion.

In one embodiment, there may be two induced draft type fans 36 located in a duct that sits on top of trailer 20. These fans 36 may draw air from the inlet ducts though the compartments and expel it out the top of a trailer 20. In one embodiment, there may be at least one additional fan 34 to draw air in through the heat exchanger 24. In one embodiment, two fans 34 add to the amount of air being drawn into the electrical generator side of trailer 20 beyond that air already being drawn in by at least one fan 36 shown in FIG. 1 on top of trailer 20. In one embodiment, the fans 34 that are located on the heat exchanger 24 bring additional air in and serve to over-pressurize the electrical generator compartment. The fans 34 bring more air in than can actually pass through the aperture that the coupling shaft 32 passes through in the barrier wall 30, so air pressure may be maintained higher on the side of trailer 20 with the electrical generator than on the side with the gas generator and free turbine. Thus, in one embodiment, by using the combination of the barrier wall 30, the separate fans 34 on the electrical generator lube oil heat exchanger and the induced draft fans 36 on top of the trailer 20, a differential pressure between the two compartments of trailer 20 may reduce the risk of fuel vapors passing into the compartment containing the electrical generator and causing an explosion or fire due to any sparks from the electrical generator.

In one embodiment, a differential pressure may be monitored during system operation by the use of a differential pressure switch that may monitor the two sides of the barrier wall 30. Upon indications of a loss of a differential pressure, which could indicate a situation where fuel could come near the electrical generator, a signal may be sent to a control system from that differential pressure switch and the unit could be shut down to reduce the risk of fire or explosion.

The present invention may be designed so that the amount of air brought through the system may be consistent with the thermal rejection of the machines on a 105° F. ambient day with the machines running in a base load configuration, in other words, with everything running at maximum output. The airflow required may be determined by the specifications that may be provided by the various manufacturers of, for example, the gas turbine engine and the AC generator, which may be the two main heat sources. There may also be provided additional cooling above an estimated thermal loading to provide a margin so that the system does not overheat, and thus be limited in its capability to generate electricity.

In one embodiment, airflow may be maintained throughout the trailer 20 by sealing devices, including gaskets. Sealing the trailer 20 to make it as air tight as possible may help cool the equipment, cool lubricating oil, and evacuate stray fuel gases.

In one embodiment, air filters may be added to the air inlets. In this embodiment, there may be a need to increase the size of the induced draft fans 36 on top of trailer 20.

In one embodiment, there may be a secondary air intake system that brings air in and provides cooling for the electrical generator internals and then expels the air back out. This air may be moved by a set of fans that are connected to the electrical generator shaft via a duct structure 38. The air for the electrical generator may be taken in through ducts forward and aft on structure 38 and then expelled through ducts on each side of the structure 38. One reason that the air for the electrical generator may be separate from the rest of the trailer 20 cooling air is that the air going in to the electrical generator internals may have a requirement from the manufacture to be filtered. Thus, on the ductwork under the intake hoods that may be forward and aft on structure 38 in one embodiment, there may be filters installed to remove dust and debris that might be in the air that is going in to the electrical generator. It is generally undesirable to have dirt going in to the internals of an electrical generator since there may also be a small amount of lubricating oil that may be inside the electrical generator. This combination of dirt and oil in an electrical generator is generally not preferable because it may call for expensive and time-consuming cleaning.

In one embodiment, the ductwork associated with the electrical generator intake and exhaust may also have sound suppression technology incorporated in to it to suppress the sound of the air moving through the system and also to suppress noise that may be coming from the generator itself. In one embodiment, both the intake filter side and the exhaust side may have sound suppression material in them to provide acceptable levels of noise attenuation.

In one embodiment, the walls, roof and floor of the trailer 20 may be designed such that they attenuate the specific frequencies generated by the machinery inside. They may be generally in the range of 6.3 lbs./sq. foot in terms of density. The walls may use a combination of structural members and interior/exterior skins to provide an air pocket between the two layers. Air helps to attenuate sound in the dead air space in the air pocket. There may also be attached to the walls and the ceiling an acoustic blanket system that further enhances the absorption of sound, both by the density of the blanket and also by the texture of the interior face of the blanket. The blanket may be made from a fire retardant material to help with fire suppression.

A targeted sound suppression may be achieved by looking at the frequencies of the machines involved. This may be advantageous rather than trying to suppress all sound at all frequencies because suppressing all sound at all frequencies may require a much more dense structure and would not be desirable due to weight considerations. Thus, by using targeted sound suppression in the ducts, walls, floor and ceiling of the trailer 20, by using properly tuned silencers 18 in the ducts, and having properly configured wall structures, the present invention may be able to provide noise levels that are generally acceptable.

In one embodiment, the inlet ducts and exhaust ducts may be equipped with louvered type dampers. Such a damper may generally remain in an open position during system operation. This damper may be kept open mechanically. If there is a fire detected inside the trailer 20, those dampers may be closed at the time that a fire extinguishing agent may be released. A suitable fire extinguishing agent may be carbon dioxide (CO₂). If CO₂ is released, the dampers may be closed. In one embodiment, the dampers may be closed by the pressure of the CO₂. In one embodiment, the fans 36 may also be shut down. This may create a situation where the fire extinguishing agent may be held captive inside the trailer 20, thus smothering a fire.

In one embodiment, the CO₂ that may be used on the trailer 20 to suppress fires may be supplied by a set of bottles. In one embodiment, there may be a number of fire detectors throughout the trailer 20. Suitable methods of detecting a fire include ultraviolet or infrared transmissions or by thermal detection. In one embodiment, there may also be a set of sensors that sense the presence of natural gas. A suitable natural gas sensor may be a catalytic type sensor.

In one embodiment, once a fire or natural gas is detected, fire extinguishing agent may be released into trailer 20. In one embodiment, the power generation system may be shut down and the fans 36 on top of the trailer 20 may be shut off. Additionally, the dampers may be closed by the release of pneumatic solenoid type cylinders. The pressure of the CO₂ may actuate a pin in a pneumatic solenoid type cylinder, allowing the dampers to close using gravity and weights. Once the extinguishing agent is released into trailer 20, it may be preferable to seal the trailer 20 so that a sufficient concentration of fire extinguishing agent may be present in trailer 20 for a sufficient period of time to extinguish any fire.

In one embodiment, a bellmouth interface may be at the inlet of the power unit trailer for incoming air to a gas generator jet engine. A bellmouth interface may be an adjustably mountable plate and may include seals such that both noise and fire extinguishing agent may be contained to seal against CO₂ leakage in the event of fire and noise leakage during normal operation of the system. A bellmouth interface may be adjustably mounted for ease of alignment of the airflow components at the inlet.

In one embodiment, an engine may be sealed to a wall of the trailer 20 via a gasket. A suitable material for this gasket is rubber. This gasket may allow movement of the engine due to thermal expansion so that it preferably does not press against a wall or some other structural member. In one embodiment, an engine may grow about 0.875 inches during its thermal cycle and this growth may be accommodated by such a gasket.

In one embodiment, the barrier wall 30 may be a wall structure that has a spreader bar and provides some lateral wall stiffness while in place and also may provide some additional stiffness to the roof structure.

In one embodiment, there may be a roof panel sealing system with removable roof panels. In one embodiment, there may be a removable panel over the electrical generator. In one embodiment, there maybe a removable panel over the gas turbine. Those panels may allow for easy installation and removal of equipment. Preferably, the roof panels may be sealed to provide protection against the weather, to contain fire extinguishing agent when release into trailer 20 and to minimize the amount of noise transmitted from within trailer 20. The roof panel sealing system may include redundant sealing features to minimize leakage. In one embodiment, the edge of the opening may have a raised lip to minimize water flow. This feature along, along with a seal arrangement and fasteners, may provide the desired sealing. A suitable seal can include a double seal made of resilient material, such as rubber or plastic, placed between the removable roof panel and trailer 20 roof. Suitable fasteners include bolts. In one embodiment, sealing may be achieved when a removable panel is fastened to the trailer roof, thus compressing the resilient seal against the raised lip. In one embodiment, the removable roof panels may be designed to attenuate noise in the same way as discussed above for the walls, roof and floor.

In one embodiment, there may be an exhaust elbow and interface 40 on FIG. 1 to a selective catalytic reduction (SCR) system. The exhaust elbow and interface 40 may include an octagonal plate in the side of the trailer 20. The octagonal plate may be a structural member that may be separate from the walls of the trailer 20 in that it may be capable of withstanding a much higher temperature and may be stiffer than the surrounding area of the trailer 20 wall. In one embodiment, the octagonal plate may be part of a system in which there may be a system of expansion joints 42 on FIG. 3. One expansion joint may be on the inside of the trailer 20 between the exhaust elbow. That expansion joint may take up movement between the exhaust collector elbow and the trailer 20 wall. If any movement occurs between those two components, the interior expansion joint may accommodate such movement. On the outside of the trailer 20 there may be a second expansion joint. This expansion joint may accommodate motion between the trailer 20 wall and the SCR exhaust duct or a standard exhaust stack.

In one embodiment, the two expansion joints may be attached to the trailer 20 wall with an offsetting bolt pattern such that the interior expansion joint may be shipped with the trailer 20, and the operator does not have to dismantle it for transportation. Once the trailer 20 may be on site, then a cover plate may be removed from the octagonal opening and that uncovers the available bolt flange that may be there to accept the outer expansion joint that may be shipped separately from the trailer 20. In addition to routing the exhaust gases from the exhaust elbow out to an exhaust structure, the use of the inner and outer expansion joints may also help to provide a seal that may help keep both noise and fire extinguishing agent inside trailer 20. Without a double expansion joint arrangement, the exhaust flow would have to pass through the trailer 20 wall and would likely create a gap there if using a single expansion joint or some similar ducting arrangement. Thus, the apparent advantages of having two expansion joints include better noise attenuation, better fire suppression and better airflow within trailer 20.

Although the present invention has been described in considerable detail, other alternative versions are possible. Therefore, the spirit and scope of the appended claims should not be limited to the description of the versions contained herein.

What is claimed is:

1. An enclosure for a mobile power generation system comprising:
a floor, end and side walls and a roof;
a plurality of ducts connected to the enclosure;
a combustion gas exhaust opening;
a plurality of devices to circulate air through the enclosure; and
at least one interior wall separating the enclosure into at least two compartments.

2. The enclosure of claim 1 wherein at least one of the ducts is removable.

3. The enclosure of claim 1 wherein at least one of the ducts further includes a screen.

4. The enclosure of claim 1 wherein at least one of the ducts further includes a filter.

5. The enclosure of claim 1 further comprising at least one component attached to at least one duct to attenuate sound.

6. The enclosure of claim 1 further comprising at least one device attached to at least one duct to direct airflow.

7. The enclosure of claim 1 further comprising at least one device attached to at least one duct to substantially stop flow in the duct.

8. The enclosure of claim 1 further comprising a fire detection system.

9. The enclosure of claim 1 further comprising an explosive gas detection system.

10. The enclosure of claim 1 further comprising a fire suppression system.

11. The enclosure of claim 1 wherein the enclosure further comprises:
at least one opening in the enclosure;
at least one removable cover for the opening;
a seal between the removable cover and the enclosure; and
a fastening arrangement to fasten the removable cover to the enclosure.

12. The enclosure of claim 11 wherein the edge of the opening further includes a raised surface.

13. The enclosure of claim 12 wherein the seal extends about at least a portion of the periphery of the removable cover and is adapted to engage against the raised surface when the removable cover is fastened to the enclosure and thus seal the enclosure opening.

14. The enclosure of claim 1 wherein the at least one interior wall further comprises an opening sized to accommodate a component able to rotate freely within the opening.

15. The enclosure of claim 14 wherein the at least one interior wall further comprises an opening sized to allow a pressure differential to exist relative to the two sides of the wall.

16. The enclosure of claim 1 wherein at least one of the floor, end and side walls, roof and ducts further comprises at least one element that suppresses sound.

17. The enclosure of claim 1 wherein the combustion gas exhaust opening further comprises:
a first expansion joint member inside the enclosure; and
a second expansion joint member outside the enclosure.

18. The enclosure of claim 17 wherein the combustion gas exhaust opening further comprises a component attached to the enclosure wall to which the first and second expansion joint members may be fastened.
